(19) United States
(12) Patent Application Publication
(10) Pub. No.: US 2026/0234389 A1
(43) Pub. Date: Aug. 13, 2026

(54) PHOTOCURABLE RESIN COMPOSITION, MOLDED ARTICLE OBTAINED THEREFROM, AND ELECTRICAL COMPONENT

(71) Applicant: Enplas Corporation, Saitama (JP)

(72) Inventors: Reo TAKAIWA, Saitama (JP); Yohei TSURUMAKI, Saitama (JP); Itsuki KOBASHI, Saitama (JP); Nanako SAKAI, Saitama (JP)

(73) Assignee: Enplas Corporation, Saitama (JP)

(21) Appl. No.: 19/403,062

(22) Filed: Nov. 27, 2025

(30) Foreign Application Priority Data
Nov. 28, 2024 (JP) 2024-207136
Nov. 25, 2025 (JP) 2025-202794

(51) Int. Cl. C08L 33/08; C08K 3/36; C08K 9/04; C08K 11/00; C08K 13/08

(52) U.S. Cl. CPC C08L 33/08; C08K 3/36; C08K 9/04; C08K 11/00; C08K 13/08; C08K 2201/005; C08L 2203/20; C08L 2205/025

(57) ABSTRACT

An object of the present invention is to provide a photocurable resin composition for obtaining a molded article having both high strength and low thermal expansion coefficient. The photocurable resin composition capable of achieving the object includes a polyfunctional acrylic resin, silica particles, and a photopolymerization initiator. The polyfunctional acrylic resin contains 20% by mass or more and 80% by mass or less of a polycyclic aliphatic acrylic resin and 20% by mass or more and 80% by mass or less of an isocyanuric acid acrylic resin, the silica particles has a 50% average particle size of 30 nm or more and less than 1.0 μm, and the amount of the silica particles is 60% by mass or more and less than 80% by mass based on the total mass of the photocurable resin composition.

This application is entitled to and claims the benefits of Japanese Patent Application No. 2024-207136 filed on Nov. 28, 2024 and Japanese Patent Application No. 2025-202794 filed on Nov. 25, 2025, the disclosures of which each including the specification and drawings are incorporated herein by reference in their entirety.

### TECHNICAL FIELD

The present invention relates to a photocurable resin composition, a molded article including the same, and an electrical component.

### BACKGROUND ART

In recent years, a molding method using a 3D printer is known as a method for manufacturing components or products having various shapes. Among various molding methods, a stereolithographic molding method using a photocurable resin composition including a photocurable resin has an advantage that a resin can be quickly cured into a desired shape.

Various resins have been proposed as the photocurable resin used in the stereolithographic molding method. For example, it has been proposed to use an acrylate having an isocyanuric ring in stereolithography (PTL 1).

Here, a molded article manufactured by a stereolithographic molding method may be used in combination with a metal member. However, a resin molded article obtained from a resin composition mainly including a resin as described in PTL 1, has a large difference in thermal expansion coefficient with a metal. Therefore, when the resin molded article is combined with the metal member, there is a problem that distortion or deformation is more likely to occur due to the difference in thermal expansion coefficient, or a problem is more likely to occur at a bonding portion.

On the other hand, as a method for reducing the thermal expansion coefficient of a resin molded article, it has been proposed to add an inorganic substance such as an inorganic filler to a resin composition for stereolithography (for example, PTL 2 and PTL 3).

### CITATION LIST

### Patent Literature

[PTL 1] Japanese Patent Application Laid-Open No. 2022-70123
[PTL 2] U.S. Patent Application Publication No. 2020/0282637
[PTL 3] Japanese Patent Application Laid-Open No. 2023-140203

### SUMMARY OF INVENTION

### Technical Problem

However, when a photocurable resin composition includes a large amount of inorganic fillers, the thermal expansion coefficient is reduced, but the amount of the resin that binds the inorganic fillers to each other is reduced. As a result, there is a problem that the strength of a molded article to be obtained is more likely to be reduced. In other words, with conventional techniques, it has been difficult to achieve both high strength and a low thermal expansion coefficient in a molded article obtained from a photocurable resin composition.

An object of the present invention is to provide a molded article having both high strength and low thermal expansion coefficient, a photocurable resin composition for obtaining the molded article, and an electrical component.

### Solution to Problem

The present invention provides the following photocurable resin compositions.

[1] A photocurable resin composition, containing: a polyfunctional acrylic resin; a silica particle; and a photopolymerization initiator, in which
the polyfunctional acrylic resin contains 20% by mass or more and 80% by mass or less of a polycyclic aliphatic acrylic resin and 20% by mass or more and 80% by mass or less of an isocyanuric acid acrylic resin; the silica particle has a 50% average particle size of 30 nm or more and less than 1.0 μm; and an amount of the silica particle is 60% by mass or more and less than 80% by mass based on a total mass of the photocurable resin composition.

[2] The photocurable resin composition according to [1] in which the silica particle is surface treated with a compound having a (meth)acryloyl group.

[3] The photocurable resin composition according to [1] or [2] in which the polycyclic aliphatic acrylic resin is tricyclodecane dimethanol diacrylate.

[4] The photocurable resin composition according to any one of [1] to [3] in which the isocyanuric acid acrylic resin is a compound represented by a general formula below:

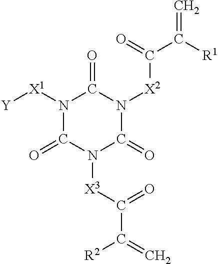

(in the general formula, X¹, X², and X³ each independently represent a linking group having 1 or more and 20 or less carbon atoms and optionally containing oxygen, R¹ and R² each independently represent a hydrogen atom or a methyl group, and Y represents a (meth)acryloyl group or a hydroxy group).

The present invention provides the following molded article.

[5] A molded article, including: a cured product of the photocurable resin composition according to any one of [1] to [4].

[6] The molded article according to [5], including: the cured product of the photocurable resin composition; and a coating layer disposed on the cured product and containing a polycyclic aliphatic acrylic resin.

The present invention provides the following electrical component.

[7] An electrical component, including: the molded article according to [5] or [6].

### Advantageous Effects of Invention

The present invention is capable of providing a molded article having both high strength and low thermal expansion coefficient, a photocurable resin composition for obtaining the molded article, and an electrical component.

### BRIEF DESCRIPTION OF DRAWINGS

FIG. 1 illustrates photographs of molded articles produced in the second reference example when each molded article is observed with a scanning electron microscope.

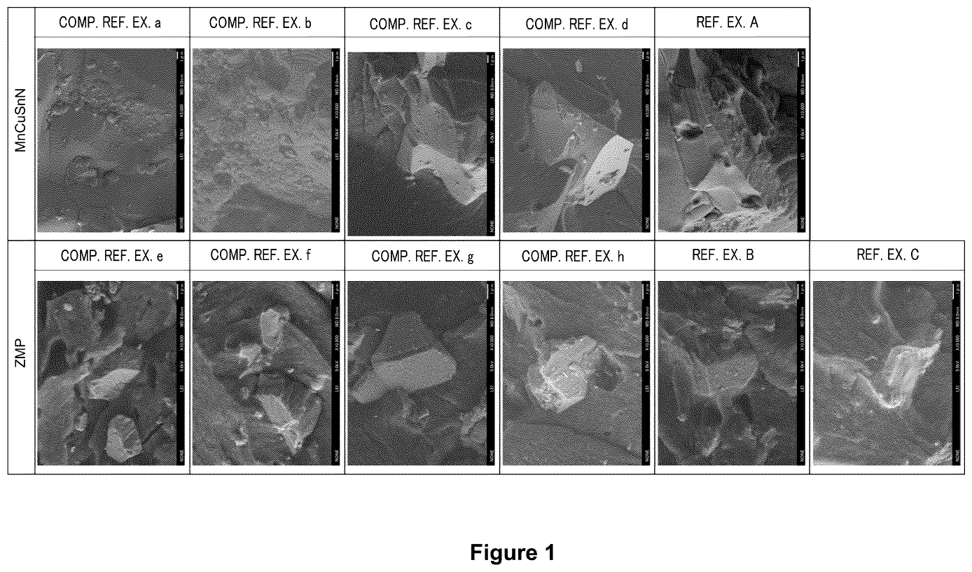

### DESCRIPTION OF EMBODIMENTS

The photocurable resin composition according to the present invention is suitably used in a stereolithographic molding method for manufacturing a molded article by irradiation with light. Therefore, hereinafter, the photocurable resin composition will be described using a photocurable resin composition in a stereolithographic molding method as an example. However, the use of the photocurable resin composition according to the present invention is not limited thereto.

The photocurable resin composition contains a polyfunctional acrylic resin, silica particles, and a photopolymerization initiator. The photocurable resin composition satisfies the following four conditions (a) to (d).
(a) The polyfunctional acrylic resin contains 20% by mass or more and 80% by mass or less of a polycyclic aliphatic acrylic resin.
(b) The polyfunctional acrylic resin contains 20% by mass or more and 80% by mass or less of an isocyanuric acid acrylic resin.
(c) The average particle size of the silica particles is 30 nm or more and less than 1.0 μm.
(d) The amount of the silica particles is 60% by mass or more and less than 80% by mass based on the total mass of the photocurable resin composition.

As shown in the condition (d), the photocurable resin composition according to the present invention contains a relatively large amount of silica particles. However, in a photocurable resin composition having a large amount of silica particles, the amount of a resin that binds the silica particles becomes relatively small. Therefore, a conventional photocurable resin composition has a problem such that the mechanical strength of a molded article to be obtained becomes low. On the other hand, according to the photocurable resin composition according to the present invention, a molded article having high mechanical strength (for example, bending strength) and a low thermal expansion coefficient can be obtained. The reason for such a feature is not clear, but is considered as follows.

In the photocurable resin composition according to the present invention, as shown in the conditions (a) and (b), the polyfunctional acrylic resin contains a predetermined amount of the polycyclic aliphatic acrylic resin and a predetermined amount of the isocyanuric acid acrylic resin. When the polycyclic aliphatic acrylic resin and the isocyanuric acid acrylic resin are combined, these resins interact with each other to form an acrylic network. In addition, when silica particles having an average particle size within a predetermined range as shown in the condition (c) are combined, the silica particles are uniformly dispersed in the acrylic network, thereby efficiently reinforcing the network. Therefore, the strength and the like of a molded article to be obtained are increased. In addition, as shown in condition (d), since the amount of the silica particles is sufficiently large, the thermal expansion coefficient of the molded article is also low. Hereinafter, each component contained in the photocurable resin composition will be described in detail.

### (Polyfunctional Acrylic Resin)

In the present specification, the polyfunctional acrylic resin refers to a resin having two or more (meth)acryloyl groups in one molecule. In addition, in the present specification, the term “(meth)acryloyl” means methacryloyl, acryloyl, or both. The same applies to the (meth)acrylate.

As described above, the polyfunctional acrylic resin contains at least a polycyclic aliphatic acrylic resin and an isocyanuric acid acrylic resin. In a range not impairing the object and effect of the present invention, the polyfunctional acrylic resin may further contain a known di- or higher functional acrylic resin (for example, a pentaerythritol acrylic resin) other than the polycyclic aliphatic acrylic resin and the isocyanuric acid acrylic resin. However, the sum of the mass of the polycyclic aliphatic acrylic resin and the mass of the isocyanuric acid acrylic resin is 40% by mass or more, preferably 80% by mass or more, and more preferably 90% by mass or more, based on the total mass of the polyfunctional acrylic resin. When the sum of the mass of the polycyclic aliphatic acrylic resin and the mass of the isocyanuric acid acrylic resin is within the range, the amount of the above-described network becomes sufficiently large, and the bending strength of a molded article to be obtained tends to be further increased.

In addition, the total mass of the polyfunctional acrylic resin in the photocurable resin composition is preferably 20% by mass or more and 40% by mass or less, and more preferably 25% by mass or more and 35% by mass or less. When the amount of the polyfunctional acrylic resin is 20% by mass or more, the silica particles are easily bonded together, and the strength of the photocurable resin composition tends to be further increased. On the other hand, when the amount of the polyfunctional acrylic resin is 40% by mass or less, the amounts of the silica particles and the photopolymerization initiator become relatively large, which tends to further reduce the thermal expansion coefficient of the cured product (molded article) and improve the photocurability of the photocurable resin.

### Polycyclic Aliphatic Acrylic Resin

In the present specification, the term “polycyclic aliphatic acrylic resin” refers to a resin having a polycyclic aliphatic structure and two or more (meth)acryloyl groups. The polycyclic aliphatic acrylic resin may be a monomer, an oligomer, or a polymer. From the viewpoint of the viscosity of the photocurable resin composition and the interaction with the isocyanuric acid acrylic resin described below, the polycyclic aliphatic acrylic resin is preferably a monomer. The polyfunctional acrylic resin may contain only one type of polycyclic aliphatic acrylic resin or two or more types thereof.

Herein, the number of rings in the polycyclic aliphatic structure is 2 or more, and is preferably 2 to 5, more preferably 2 to 4, and still more preferably 2 or 3. Examples of the polycyclic aliphatic structure include condensed polycyclic cycloalkane structures such as bicycloundecane, tricyclodecane, norbornane, adamantane, and decahydronaphthalene; and a spirocyclic cycloalkane structures such as spiro[3.4]octane, spiro[4.4]nonane, and spiro[4.5]decane. Among these, the polycyclic aliphatic structure is preferably a condensed polycyclic cycloalkane structure, and more preferably a tricyclodecane structure.

On the other hand, the number of (meth)acryloyl groups is 2 or more, and is preferably 2 to 6, more preferably 2 to 4, and still more preferably 2 or 3. The (meth)acryloyl group may be directly bonded to the polycyclic aliphatic structure, or may be bonded through a linking group such as an alkylene group or an alkyleneoxy group.

Specific examples of the polycyclic aliphatic acrylic resin include tricyclodecane dimethanol di(meth)acrylate, adamantane diol di(meth)acrylate, and adamantane triol di(meth)acrylate. Among these, from the viewpoint of facilitating the formation of the above-described network by interacting with the isocyanuric acid acrylic resin described below, tricyclodecane dimethanol di(meth)acrylate is particularly preferable.

The amount of the polycyclic aliphatic acrylic resin is 20% by mass or more and 80% by mass or less and is more preferably 30% by mass or more and 70% by mass or less, based on the total mass of the polyfunctional acrylic resin. As described above, when the amount of the polycyclic aliphatic acrylic resin is within the range, the strength of a cured product (molded article) to be obtained from the photocurable resin composition is more likely to become high.

### Isocyanuric Acid Acrylic Resin

The isocyanuric acid acrylic resin is a resin having an isocyanuric ring and two or more (meth)acryloyl groups. The isocyanuric acid acrylic resin may be a monomer, an oligomer, or a polymer. From the viewpoint of the viscosity of the photocurable resin composition and the interaction with the polycyclic aliphatic acrylic resin, the isocyanuric acid acrylic resin is preferably a monomer. The polyfunctional acrylic resin may contain only one type of isocyanuric acid acrylic resin or two or more types thereof.

Here, the number of isocyanuric rings included in the isocyanuric acid acrylic resin is 1 or more, and may be 2 or more, but is usually 1. In addition, the number of (meth)acryloyl groups included in the isocyanuric acid acrylic resin is 2 or more, and is usually 2 or 3, preferably 3. When the isocyanuric acid acrylic resin has three (meth)acryloyl groups, the isocyanuric acid acrylic resin easily forms the above-described network in the cured product, and the strength of the cured product (molded article) tends to be further increased.

Examples of the isocyanuric acid acrylic resin include compounds represented by the following general formula.

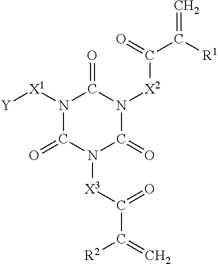

In the general formula, X¹, X², and X³ each independently represent a linking group having 1 or more and 20 or less carbon atoms and optionally containing oxygen. X¹, X², and X³ may be the same or different from each other. Specific examples of the linking group which may be X¹, X², and X³ include alkylene groups represented by —(CₙH₂ₙ)— (n is 1 or more and 10 or less, preferably 1 or more and 6 or less, and more preferably 2 or 3); (poly)alkyleneoxy groups represented by —(CₙH₂ₙO)ₘ— (n is 1 or more and 10 or less, preferably 1 or more and 6 or less, and more preferably 2 or 3, and m is 1 or more and 10 or less, preferably 1 or more and 6 or less, and more preferably 1 or more and 3 or less); groups derived from ε-caprolactone represented by —(C(═O)C₅H₁₀O)ₘ— (m is 1 or more and 3 or less, preferably 1 or 2); and combinations thereof. In addition, a substituent such as a hydroxy group may be bonded to the linking group. Among these, the linking group is particularly preferably ethyleneoxy group represented by —(C₂H₄O)—.

In the general formula, R¹ and R² each independently represent a hydrogen atom or a methyl group. R¹ and R² may be the same or different from each other. Further, in the general formula, Y represents a (meth)acryloyl group or a hydroxy group.

The isocyanuric acid acrylic resin may be a synthetic product or a commercially available product. Examples of commercially available products of the isocyanuric acid acrylic resin having three (meth)acryloyl groups include NK ESTER A-9300 and NK ESTER A-9300-1CL (both manufactured by Shin-Nakamura Chemical Co., Ltd.), and ARONIX M-327 (manufactured by TOAGOSEI CO., LTD.). In addition, examples of commercially available products of the isocyanuric acid acrylic resin having two (meth)acryloyl groups include ARONIX M-215 (manufactured by TOAGOSEI CO., LTD.). Further, examples of commercially available products of a mixture of the isocyanuric acid acrylic resin having three (meth)acryloyl groups and the isocyanuric acid acrylic resin having two (meth)acryloyl groups include ARONIX M-313 and ARONIX M-315 (both manufactured by TOAGOSEI CO., LTD.).

Among these, the isocyanuric acid acrylic resin is particularly preferably a compound represented by the following formula from the viewpoint of facilitating the formation of a desired network by interacting with the polycyclic aliphatic acrylic resin.

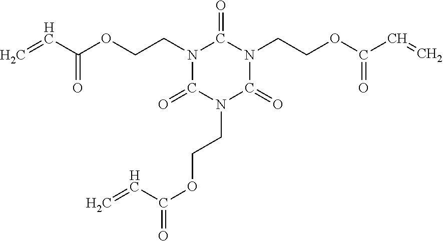 [SMILES: C=CC(=O)OCCn1c(=O)n(CCOC(=O)C=C)c(=O)n(CCOC(=O)C=C)c1=O]

The amount of the isocyanuric acid acrylic resin is 20% by mass or more and 80% by mass or less, more preferably 30% by mass or more and 70% by mass or less, based on the total mass of the polyfunctional acrylic resin. As described above, when the amount of the isocyanuric acid acrylic resin is within the range, the strength of a cured product (molded article) to be obtained from the photocurable resin composition tends to be further increased.

### (Silica Particles)

The silica particles are particles having a 50% average particle size of 30 nm or more and less than 1.0 μm. In the present specification, the 50% average particle size is a median value of a volume particle size distribution measured by a laser diffraction method. However, when the particle size is out of the range (less than 30 nm) of a diffraction-type particle size distribution measuring device, the average value of particle size measured by randomly selecting 20 particles from a photograph captured by a transmission electron microscope is used. The 50% average particle size is preferably 100 nm or more and 1.0 μm or less, and more preferably 300 nm or more and 800 nm or less. As described above, when the 50% average particle size of the silica particles is 30 nm or more and less than 1.0 μm, the silica particles are easily uniformly dispersed in the network formed by the polycyclic aliphatic acrylic resin and the isocyanuric acid acrylic resin, and the mechanical strength (for example, bending strength) of a molded article to be obtained is significantly increased. In addition, when the 50% average particle size of the silica particles is 30 nm or more, even when the amount of the silica particles in the photocurable resin composition is 60% by mass or more based on the total mass of the photocurable resin composition, the viscosity of the photocurable resin composition is less likely to excessively increased. From the viewpoint of durability of the end part of a molded article, the 50% average particle size of the silica particles is preferably 30 nm or more and 100 nm or less, and more preferably 50 nm or more and 100 nm or less.

The shape of the silica particle is not particularly limited as long as the 50% average particle size is satisfied. For example, the shape of the silica particle may be spherical, polygonal, or irregular, but is more preferably spherical from the viewpoint of easily reinforcing the acrylic resin network.

The specific surface area of the silica particles can be, for example, 10 m²/g or more and 150 m²/g or less. When the specific surface area of the silica particles is within the range, the contact area with the above-described polyfunctional acrylic resin becomes sufficiently large, and the strength of a molded article to be obtained is more likely to become high. The specific surface area is preferably 20 m²/g or more and 130 m²/g or less, and more preferably 30 m²/g or more and 100 m²/g or less. The specific surface area is a value measured by a BET method using nitrogen.

The oil absorption amount per unit area (m²) of the surface area of the silica particles is preferably 0.0003 to 0.01 mL. The oil absorption amount is a value specified as follows. Linseed oil is added dropwise and mixed with 2 g of silica particles to be measured. Then, based on the amount of linseed oil when the mixture turns into a paste, the oil absorption amount per 1 g is calculated by the following conversion expression. The measurement is performed by adding the linseed oil dropwise while mixing the linseed oil drop by drop. That is, the linseed oil is added dropwise and mixed in order, and the amount of the linseed oil when the mixture turns into a paste is specified.

(Oil absorption amount per 1 g of silica particles)=amount (mL) of linseed oil required to make the mixture into a paste/amount (g) of silica particles to be measured

The calculated oil absorption amount per 1 g of silica particles is divided by the specific surface area of the silica particles to calculate the oil absorption amount per unit area (m²) of the surface area of the silica particles.

When the oil absorption amount per unit area (m²) of the surface area of the silica particles is within the range, the viscosity is more likely to fall within a desired range when the silica particles are mixed with the polyfunctional acrylic resin.

Further, when the silica particles are dispersed in cyclohexanone at a mass ratio of 1:1, it is also preferable that 1100 of the X-ray small-angle scattering spectrum/half width of the X-ray small-angle scattering spectrum is 300 or less. When I100 of a small-angle scattering spectrum of the dispersion liquid/half width of the X-ray small-angle scattering spectrum is 300 or less, the filling rate of the silica particles in the resin composition is more likely to become high. That is, the silica particles are less likely to aggregate and are easily uniformly dispersed. As a result, the strength of a molded article to be obtained is more likely to become high. The I100/half width of the small-angle scattering spectrum is more preferably 250 or less, still more preferably 100 or less, and particularly preferably 85 or less. The “I100 of the X-ray small-angle scattering spectrum” represents a scattered intensity of a peak top of the largest peak in the X-ray small-angle scattering spectrum. In addition, the half width is a width at half the height of the peak. The X-ray small-angle scattering spectrum can be measured, for example, using synchrotron radiation as an X-ray source and R-AXIS as a detector. In addition, the measurement is performed with a camera length of 4 m from the X-ray source and with the measurement sample (silica particles) accommodated in a quartz tube having a size of 1 mm.

Further, the silica particles may be surface-modified with a surface modifier or the like. Examples of the surface modifier include silane coupling agents and silazanes. When the surface of the silica particles is modified with a silane coupling agent, the affinity between the silica particles and the polyfunctional acrylic resin is more likely to become high, and the dispersibility of the silica particles in the photocurable resin composition is more likely to become high. As a result, the strength of the molded article of the photocurable resin composition is more likely to become further high.

The type of silane coupling agent is not particularly limited as long as it has an affinity with the polyfunctional acrylic resin and the silica particles. Examples of the silane coupling agent include amino group-containing silane coupling agents such as N-(2-aminoethyl)-3-aminopropyltrimethoxysilane, N-(2-aminoethyl)-3-aminopropyltriethoxysilane, 3-aminopropyltrimethoxysilane, and 3-aminopropyltriethoxysilane; vinyl group-containing silane coupling agents such as vinyltrimethoxysilane, vinyltriethoxysilane, and diethoxymethylvinylsilane; (meth)acryloyl group-containing silane coupling agents such as 3-methacryloxypropyltrimethoxysilane, 3-methacryloxypropyltriethoxysilane, and 3-acryloxypropyltrimethoxysilane; isocyanate group-containing silane coupling agents such as 3-isocyanatepropyltriethoxysilane; epoxy group-containing silane coupling agents such as 3-glycidoxypropyltrimethoxysilane and 3-glycidoxypropyltriethoxysilane; ureido group-containing silane coupling agents such as 3-ureidopropyltriethoxysilane; mercapto group-containing silane coupling agents such as 3-mercaptopropyltrimethoxysilane; phenyl group-containing silane coupling agents such as phenyltrimethoxysilane, phenyltriethoxysilane, and dimethoxyphenylmethylsilane; and amino phenyl group-containing silane coupling agents such as aminophenyltrimethoxysilane, aminophenyltriethoxysilane, and dimethoxyaminophenylmethylsilane. In addition, examples of the silazane include hexamethyldisilazane. These can be used alone or in combination of two or more types thereof.

Among the above-described silane coupling agents, a compound having a (meth)acryloyl group, that is, a (meth)acryloyl group-containing silane coupling agent is preferable from the viewpoint of having satisfactory affinity with the polyfunctional acrylic resin. In addition, when the silane coupling agent has a (meth)acryloyl group, the silane coupling agent polymerizes with the above-described polyfunctional acrylic resin. Therefore, the silica particles treated with the silane coupling agent are more likely to be further uniformly dispersed in the polyfunctional acrylic resin.

The amount of the silica particles is 60% by mass or more and less than 80% by mass, and is preferably 65% by mass or more and 75% by mass or less, based on the total mass of the photocurable resin composition. As described above, when the amount of the silica particles is within the range, the linear expansion coefficient of a molded article to be obtained becomes sufficiently low, and the strength of a molded article to be obtained is further increased.

### (Photopolymerization Initiator)

The photopolymerization initiator may be a compound that can absorb light (for example, ultraviolet light or visible light) emitted for curing the photocurable resin composition and thus can generate an active species, thereby initiating polymerization of the above-described polyfunctional acrylic resin or the like. The photocurable resin composition may contain only one type of photopolymerization initiator or two or more types thereof.

Examples of the photopolymerization initiator include alkylphenone-based radical polymerization initiators, acylphosphine oxide-based radical polymerization initiators, and oxime ester-based radical polymerization initiators. Examples of the alkylphenone-based photopolymerization initiator include 2,2-dimethoxy-1,2-diphenylethane-1-one, 1-hydroxy-cyclohexyl-phenyl-ketone, 2-hydroxy-2-methyl-1-phenyl-propane-1-one, 1-[4-(2-hydroxyethoxy)-phenyl]-2-hydroxy-2-methyl-1-propane-1-one, 2-hydroxy-1-{4-[4-(2-hydroxy-2-methyl-propionyl)-benzyl]phenyl}-2-methyl-propane-IN-phenylglycine-one, 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, and the like. Examples of the acylphosphine oxide-based photopolymerization initiator include bisphenyl(2,4,6-trimethylbenzoyl) phosphine oxide and phenylbis(2,4,6-trimethylbenzoyl) phosphine oxide. Examples of the oxime ester-based radical polymerization initiator include 2-benzoyloxyimino-4′-(phenylthio) octanophenone and 6-[1-(acetyloxyimino)ethyl]-9-ethyl-9H-carbazole-3-yl-2-methylphenyl ketone.

The amount of the photopolymerization initiator in the photocurable resin composition is preferably 0.5 parts by mass or more and 3.0 parts by mass or less, and more preferably 0.7 parts by mass or more and 2.0 parts by mass or less, based on 100 parts by mass of the total mass of the acrylic resin (the above-described polyfunctional acrylic resin and other resins having a (meth)acryloyl group). When the amount of the photocurable resin composition is within the range, the photocurable resin composition can be efficiently cured.

### (Additional Component)

In a range not impairing the object and effect of the present invention, the photocurable resin composition may further contain a component other than the polyfunctional acrylic resin, the silica particles, and the photopolymerization initiator. Examples of the additional component include photocurable resins other than the polyfunctional acrylic resin (for example, monofunctional acrylic resins), other curable resins such as epoxy resins, and various additives. Examples of the additives include dispersion stabilizers, colorants, UV antioxidants, polymerization inhibitors, antifoaming agents, fillers, absorbers, photosensitizers, and toughening agents.

### (Viscosity of Photocurable Resin Composition)

The viscosity of the photocurable resin composition is appropriately selected depending on the type of stereolithographic molding method. For example, in a laminating type stereolithographic molding method described below, the viscosity of the photocurable resin composition at 25° C. is usually preferably 1 Pa's or more and 1,000 Pa's or less, and more preferably 10 Pa's or more and 800 Pa's or less. The viscosity is measured by rotating a sample at a shear rate of 1 (1/s) using a rheometer (for example, Discovery HR-2 manufactured by TA Instruments) and reading the value after the rotation has stabilized (for example, after 90 seconds). When the viscosity of the photocurable resin composition is within the range, the fluidity of the photocurable resin composition during stereolithography is more likely to become suitable.

### (Method for Preparing Photocurable Resin Composition)

The method for preparing the photocurable resin composition is not particularly limited as long as the polyfunctional acrylic resin, the silica particles, the photopolymerization initiator, and an additional component as necessary can be uniformly mixed. For example, all components may be mixed at once. On the other hand, the polyfunctional acrylic resin and the photopolymerization initiator may be mixed first, and then the silica particles and an additional component may be mixed. The mixing method can be the same as a known stirring method or kneading method.

### (Stereolithographic Molding Method Using Photocurable Resin Composition)

The photocurable resin composition can be used in various stereolithographic molding methods. An example of the stereolithographic molding methods is the following laminating type stereolithographic molding method.

In this method, the photocurable resin composition is supplied onto a stage to form a layer (first layer) having a desired thickness and composed of the photocurable resin composition. In this case, the method for supplying the photocurable resin composition is not particularly limited, and for example, a method using a T-die can be used. In addition, the surface of the photocurable resin composition supplied from the T-die may be smoothed with a squeegee, a doctor knife, or the like as necessary. Then, a predetermined region of the first layer composed of the photocurable resin composition is irradiated with light to cure the photocurable resin composition in the irradiated region. The method for irradiating the region with light is not particularly limited, and for example, laser light may be scanned, or exposure may be performed all at once through a mask or the like. In this case, the wavelength of the light used for irradiation is not particularly limited, and is appropriately selected depending on the type of photopolymerization initiator described above, but for example, light having a wavelength of 100 nm or more and 400 nm or less is preferable.

The photocurable resin composition is further supplied onto the cured product of the first layer to form a layer (second layer) having a desired thickness. Then, a desired region of the second layer is irradiated with light in the same manner as described above to cure the photocurable resin composition. By repeating these steps, a molded article including the cured product of the photocurable resin composition is obtained.

After the production of the molded article or during the production of the molded article, a heat treatment may be performed as necessary to promote the curing of the photocurable resin composition.

### (Use of Molded Article)

The molded article including the cured product of the photocurable resin composition has high mechanical strength and a low thermal expansion coefficient as described above. Therefore, the molded article can be used for various use such as electrical components, electronic devices, electrical equipment, medical devices, home appliances, robot-related products, and vehicle-related products. Among these, the molded article is useful in the manufacture of electrical components in which a composite component is often manufactured by combining the molded article with a metal.

### First Variation

In the above, a method for manufacturing a molded article using a photocurable resin composition containing a relatively large amount of silica particles has been described. When the molded article is manufactured using a photocurable resin composition containing a relatively large amount of inorganic particles, the inorganic particles are more likely to be exposed on the surface of the molded article. Therefore, when the molded article is in contact with another member, the inorganic particles may fall off. In order to prevent such falling off of inorganic particles, it has been known to provide a coating layer on the surface of a molded article. However, when the inorganic particles are exposed on the surface of the molded article, the adhesiveness with the coating layer mainly composed of a resin is low, and the durability of the coating layer cannot be sufficiently obtained.

For such a problem, the present inventors have found that the adhesiveness between a base material and a coating layer is significantly improved, thereby increasing the durability of the coating layer by employing a molded article including a base material and a coating layer having the following feature. That is, the base material contains an acrylic resin and inorganic particles having a 50% average particle size of 30 nm or more and less than 1.0 μm (preferably 0.1 μm or more and less than 1.0 μm), the content of the inorganic particles in the base material is 60% by mass or more and less than 80% by mass, and the coating layer is disposed on the base material and contains an acrylic resin of the same type as the acrylic resin in the base material. The acrylic resin contained in the base material and the acrylic resin contained in the coating layer do not need to be completely the same. For example, when the base material contains a plurality of acrylic resins, the coating layer may contain at least one of the acrylic resins contained in the base material. Alternatively, the base material may contain at least one of the acrylic resins contained the coating layer.

The reason why the durability of the coating layer is increased in the molded article including the base material and the coating layer as described above is not clear, but is considered as follows. Since the base material contains 60% by mass or more of the inorganic particles, the inorganic particles are more likely to be exposed on the surface of the base material. In addition, in this case, since the 50% average particle size of the inorganic particles is 30 nm or more and less than 1.0 μm (preferably 0.1 μm or more and less than 1.0 μm), an appropriate unevenness is formed on the surface of the base material. As a result, an appropriate anchor effect occurs between the base material and the coating layer. In addition, since the acrylic resin contained in the base material and the acrylic resin contained in the coating layer are of the same type, the affinity between these resins is high. It is considered that the anchor effect due to the unevenness and the affinity between the acrylic resins act synergistically, thereby increasing the durability of the coating layer.

The type of inorganic particles contained in the base material is not particularly limited, but is preferably the silica particles described in the above-described photocurable resin composition from the viewpoint of hardness, handleability, and the like. The type of acrylic resin contained in the base material is not particularly limited either, but is preferably the polyfunctional acrylic resin (polycyclic aliphatic acrylic resin and isocyanuric acid acrylic resin) described in the photocurable resin composition from the viewpoint of the strength and the like of a molded article to be obtained. That is, the base material is preferably the cured product of the above-described photocurable resin composition.

On the other hand, the coating layer is preferably a layer containing the above-described polycyclic aliphatic acrylic resin. Such a coating layer can be obtained, for example, by applying a resin composition for a coating layer—the resin composition containing the above-described polycyclic aliphatic acrylic resin and the above-described photopolymerization initiator-onto the base material and curing the applied composition. The amount of the photopolymerization initiator in the composition for a coating layer is preferably 0.5 parts by mass or more and 3.0 parts by mass or less based on 100 parts by mass of the total amount of acrylic resins (polycyclic aliphatic acrylic resin and other resins having a (meth)acryloyl group). In addition, the composition for a coating layer may contain an additional component as necessary, and for example, may further contain at least one of the isocyanuric acid acrylic resin, other resins, various additives, and the like.

The method for applying the resin composition for a coating layer is appropriately selected depending on the shape of the base material and the desired film thickness. For example, a known application method or printing method such as application with a brush, ink jet application, spray application, spin coating, or dip coating can be used.

The curing method of the composition for a coating layer is not particularly limited, and for example, laser light may be scanned or exposure may be performed all at once. In this case, the wavelength of the light used for irradiation may be any wavelength as long as it can excite the above-described photopolymerization initiator and generate an active species, and is appropriately selected depending on the type of photopolymerization initiator described above. In this case, light having a wavelength of 100 nm or more and 400 nm or less is preferable.

### Second Variation

In the description of the above-described photocurable resin composition, silica particles have been described as the filler. However, depending on the use or the like of the photocurable resin composition, it is also possible to use inorganic particles other than the silica particles as the filler. However, when the inorganic particles and the resin are mixed, the affinity therebetween often becomes a problem. In the related art, in order to solve such a problem, the inorganic particles have been treated with a coupling agent to increase the affinity with the resin. However, there are various coupling agents, and it is necessary to select the coupling agent in consideration of the affinity with the inorganic particles and the affinity with the resin. In addition, depending on the type of inorganic particles, it may be difficult to perform the treatment itself with a coupling agent. In addition, there is no previous knowledge for particles having a negative thermal expansion characteristic (also referred to as “negative expansion material” in the present specification) that have been developed in recent years in particular, and therefore, it is necessary to select the coupling agent each treatment.

The present inventors have found that the above-described problem can be solved by performing the following steps: forming a metal-containing film that contains a metal or a metal oxide on the surface of the filler by an atomic layer deposition (ALD) method; and disposing a coupling agent on the metal-containing film. This method forms a metal-containing film on the surface of the filler. Therefore, it is possible to select a specific coupling agent from a group of coupling agents that have high affinity with a metal-containing film, without considering the type of filler but by taking into consideration only the affinity with the resin. Therefore, according to this method, there is an advantage that the selection of the coupling agent is very easy and it is not necessary to perform excessive trial and error. In addition, the ALD method can uniformly form a dense film on the surface of the filler. Therefore, it is possible to uniformly dispose the coupling agent on the entire surface of the filler, and the affinity between the inorganic particles and the resin after performing this method becomes very high.

The type of filler that can be used in this method is not particularly limited, and various types or variously shaped particles can be used. Examples of the filler also include negative expansion materials such as MnCuSnN and ZMP (ZnO: 30 to 40% by mass, MgO: 1 to 9% by mass, NH₄H₂PO₄: 55 to 65% by mass, manufactured by Mitsui Mining & Smelting Co., Ltd.).

On the other hand, examples of the metal or the metal oxide constituting the metal-containing film include silicon dioxide (SiO₂), Al₂O₃, and TiO₂. In the present variation, a metalloid such as Si is also treated as a metal. Among these, silicon dioxide is preferable from the viewpoint of affinity with a coupling agent.

The method for forming the metal-containing film is the same as a known ALD method. The thickness of the metal-containing film is preferably large enough not to be affected by the filler surface and small enough not to be peeled off, and is preferably 4 nm or more and 170 nm or less and more preferably 10 nm or more and 80 nm or less. When the thickness of the metal-containing film is within the range, the metal-containing film is more likely to become a dense film.

In addition, the type of coupling agent is appropriately selected depending on the type of metal or metal oxide constituting the metal-containing film. For example, when the metal-containing film is SiO₂, various silane coupling agents can be used, and any silane coupling agent may be appropriately selected depending on the type of resin. The method for disposing the silane coupling agent on the metal-containing film can be performed according to a conventional method.

### EXAMPLES

Hereinafter, the present invention will be described using Examples and Comparative examples, but the present invention is not limited to the following Examples in any way.

### 1. EXAMPLES

### 1-1. Preparation of Materials

The following materials were used in Examples and Comparative examples.

### (Polycyclic Aliphatic Acrylic Resin)

IRR-214K (tricyclodecane dimethanol diacrylate, manufactured by Daicel-Allnex Ltd.)

### (Isocyanuric Acid Acrylic Resin)

Tris[2-(acryloyloxy)ethyl] isocyanurate (manufactured by Sigma-Aldrich)
A-9300S (tris[2-(acryloyloxy)ethyl] isocyanurate, manufactured by Shin-Nakamura Chemical Co., Ltd., product name: NK ESTER A-9300S)

### (Photopolymerization Initiator)

BAPO (phenylbis(2,4,6-trimethylbenzoyl) phosphine oxide, manufactured by Sigma-Aldrich)

### (Silica Particles)

SC2500-SMJ (surface-treated with methacryl silane, manufactured by Admatechs Co., Ltd., product name: Admafine SC2500-SMJ, 50% average particle size (median value of volume particle size distribution measured by laser diffraction method): 0.5 μm)
NP-30 (manufactured by AGC Si-Tech Co., Ltd. SANSFARE NP-30, 50% average particle size (median value of volume particle size distribution measured by laser diffraction method): 3 μm)
R7200 (surface-treated with methacryl silane, manufactured by Nippon Aerosil Co., Ltd., product name: AEROSIL R7200, 50% average particle size (average value of particle size measured by randomly selecting 20 particles from a photograph captured by a transmission electron microscope): 12 nm)
YA050C-SM1: (surface-treated with methacryl silane, manufactured by Admatechs Co., Ltd., product name: ADMANANO YA050-SM1, 50% average particle size (median value of volume particle size distribution measured by laser diffraction method): 50 nm, specific surface area: 65 m²/g)
YC100C-SM2 (surface-treated with methacryl silane, manufactured by Admatechs Co., Ltd., product name: Admafine YC100C-SM2, 50% average particle size (median value of volume particle size distribution measured by laser diffraction method): 100 nm, specific surface area: 30 m²/g)

### Others

A-HD-N(hexanediol diacrylate, manufactured by Shin-Nakamura Chemical Co., Ltd., product name: NK ESTER A-HD-N)
Nano Ace D-800 (talc, manufactured by Nippon Talc Co., Ltd., 50% average particle size: 0.8 μm (median value of volume particle size distribution measured by laser diffraction method))
BYK111 (dispersant, manufactured by BYK-Chemie GmbH, product name: DISPERBYK 111)

### 1-2. Preparation of Photocurable Resin Composition

### Example 1

Each acrylic resin and the photopolymerization initiator shown in Table 1 were weighed and placed in a beaker in the mass ratio shown in Table 1. Specifically, 80 parts by mass of the polycyclic aliphatic acrylic resin (tricyclodecane dimethanol diacrylate), 20 parts by mass of the isocyanuric acid acrylic resin (tris[2-(acryloyloxy)ethyl] isocyanurate), and 1.0 part by mass of the photopolymerization initiator (phenylbis(2,4,6-trimethylbenzoyl) phosphine oxide) were weighed and placed in a beaker. These compounds were stirred while being heated at 60° C. for 2 hours, and it was confirmed that a homogeneous solution was obtained. Thereafter, 235 parts by mass of the silica particles (SC2500-SMJ) were further added to the solution, which was kneaded and defoamed with a planetary centrifugal mixer SK-300TVS (manufactured by Shashin Kagaku Co., Ltd.). As a result, a photocurable resin composition was prepared.

### Examples 2 to 7 and Comparative Examples 1 to 10

Photocurable resin compositions were prepared by the same method as in Example 1, except that the type and amount of the acrylic resin, the type and amount of the silica particles, and the amount of the photopolymerization initiator were changed as shown in Tables 1 and 2.

### Comparative Example 11

A photocurable resin composition was prepared by the same method as in Example 1, except that the type and amount of the acrylic resin, the amount of the photopolymerization initiator, and the type and amount of the silica particles were changed as shown in Table 2, and talc was used instead of the silica particles. In addition, the dispersant was added after the acrylic resin and the photopolymerization initiator were mixed and before the talc was mixed.

### 1-3. Evaluation Method

For each photocurable resin composition prepared in Examples 1 to 7 and Comparative examples 1 to 11, a stereolithographic object was prepared by the following method, and each produced stereolithographic object was evaluated. The results are shown in Tables 1 and 2.

### (Method for Producing Stereolithographic Object)

A 1 mm-thick spacer having a donut shape (a disk having a size of φ80 mm and having a through-hole of φ50 mm at the center) was placed on a glass plate that had been subjected to a release treatment. The above-described photocurable resin composition was poured into a recessed portion formed by a wall surrounding the through-hole of the spacer and the glass plate. Thereafter, another glass plate that had been subjected to a release treatment was placed on the spacer to sandwich the photocurable resin composition. Then, the photocurable resin composition was irradiated with light having a wavelength of 365 nm from both surfaces for 15 seconds each using an ultra-high pressure mercury lamp (UV-800, manufactured by OAK Corporation) so that the integrated light amount was about 200 mW/cm². Thereafter, the photocurable resin composition was heated in an oven at 200° C. for 1 hour to obtain a stereolithographic object.

### (Method for Producing Test Piece)

The above-described stereolithographic object (molded article) was cut into a size of 2.8 mm×15.0 mm using a small CO₂ laser processing machine (HAJIME CL1, manufactured by Oh-Laser Co., Ltd.), and the cut piece was used as a test piece.

### (Measurement of Bending Strength)

The bending strength was measured with a universal tester (manufactured by Instron Corporation). Specifically, the bending strength was measured by a three-point bending test at a crosshead speed of 10 mm/min using a fixture with a span of 10 mm and upper/lower indenter diameters of 0.1 mm. The number of samples N was set to 5, and the average value of the maximum stress in the test was set as the value of the bending strength.

### (Measurement of Thermal Expansion Coefficient)

The thermal expansion coefficient was evaluated using a thermal analysis device Thermoplus EV02 TMA8311/LN2 (manufactured by Rigaku Corporation) with reference to JIS K-7197. Specifically, the thermal analysis was performed under a nitrogen atmosphere at a load of ~49.0 mN and a temperature rising rate of 5° C./min, and the thermal expansion coefficient in a range of ~40° C. to 150° C. was specified.

### (Evaluation of Durability of End Part of Molded Article)

A 1 mm-thick spacer having a donut shape (a disk having a size of φ80 mm and having a through-hole of φ50 mm at the center) was placed on a black anodized aluminum plate (0.5 mm thick) that had been subjected to a release treatment. The above-described photocurable resin composition was poured into a recessed portion formed by a wall surrounding the through-hole of the spacer and the black plate. Thereafter, a glass plate that had been subjected to a release treatment was disposed on the spacer. Then, half of the region (a semicircular region) of the through-hole of the glass plate was masked with a black tape. In this state, the photocurable resin composition was irradiated with light from the glass plate side for 5 seconds using a UV lamp (wavelength: 365 nm). After wiping off the uncured portion with a nonwoven fabric, the uncured portion was wiped off with ethanol to obtain a stereolithographic object (molded article).

The durability of the end part of the molded article was evaluated by pressing a 0.5 mm-thick anodized aluminum plate vertically against an end surface (a portion at the chord) of the semicircular stereolithographic object (molded article) produced by the above-described method and rubbing the end surface. At this time, a case where no shaving powder was generated from the stereolithographic object was evaluated as A (durability was satisfactory), a case where almost no shaving powder was generated was evaluated as B, a case where shaving powder was generated was evaluated as C, and a case where a large amount of shaving powder was generated was evaluated as D (durability was poor).

### 1-4. Results

TABLE 1

| | | Examples | | | | | | |
|---|---|---|---|---|---|---|---|---|
| | | 1 | 2 | 3 | 4 | 5 | 6 | 7 |
| Polycyclic aliphatic | IRR-214K | 80 | 70 | 70 | 25 | 20 | 70 | 70 |
| acrylic resin | | | | | | | | |
| Isocyanuric acid | Tris[2- | 20 | 30 | 30 | | | 30 | 30 |
| acrylic resin | (acryloyloxy)ethyl]isocyanurate | | | | | | | |
| | A-9300S | | | | 75 | 80 | | |
| Other acrylic resins | A-HD-N | | | | | | | |
| Silica particle | SC2500-SMJ | 235 | 235 | 152 | 235 | 235 | | |
| | (D50: 0.5 μm) | | | | | | | |
| | R7200 | | | | | | | |
| | (D50: 12 nm) | | | | | | | |
| | NP-30 | | | | | | | |
| | (D50: 3 μm) | | | | | | | |
| | YA050C-SM1 | | | | | | 152 | |
| | (D50: 50 nm) | | | | | | | |
| | YC100C-SM2 | | | | | | | 188 |
| | (D50: 100 nm) | | | | | | | |
| Photopolymerization | BAPO | 1.0 | 0.7 | 0.7 | 1.0 | 1.0 | 1.0 | 1.0 |
| initiator | | | | | | | | |
| Other components | D-800 (talc) | | | | | | | |
| | BYK 111 | | | | | | | |

| | | | | | | | |
|---|---|---|---|---|---|---|---|
| [a] Polycyclic aliphatic acrylic resin | 80 | 70 | 70 | 25 | 20 | 70 | 70 |
| content in all acrylic resins [wt %] | | | | | | | |
| [b] Isocyanuric acid acrylic resin | 20 | 30 | 30 | 75 | 80 | 30 | 30 |
| content in all acrylic resins [wt %] | | | | | | | |
| [c] 50% average particle size of silica | 0.5 | 0.5 | 0.5 | 0.5 | 0.5 | 0.05 | 0.1 |
| particles (talc) [μm] | | | | | | | |
| [d] Silica particle content based on | 70 | 70 | 60 | 70 | 70 | 60 | 65 |
| total resin composition [wt %] | | | | | | | |
| Bending strength [MPa] | 176 | 200 | 181 | 199 | 174 | 184 | 181 |
| Thermal expansion coefficient [ppm/K] | 24 | 25 | 35 | 22 | 20 | 34 | 33 |
| Durability of molded body | C | C | C | C | C | A | A |

TABLE 2

| | | Comparative example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Polycyclic aliphatic | IRR-214K | 90 | 100 | 0 | 70 | 70 | 50 | 60 | 70 | 70 | | 70 |
| acrylic resin | | | | | | | | | | | | |
| Isocyanuric acid | Tris[2- | | | | 30 | 30 | 50 | 40 | 30 | 30 | 30 | 30 |
| acrylic resin | (acryloyloxy)ethyl] | | | | | | | | | | | |
| | isocyanurate | | | | | | | | | | | |
| | A-9300S | 10 | | 100 | | | | | | | | |
| Other acrylic resins | A-HD-N | | | | | | | | | | 70 | |
| Silica particle | SC2500-SMJ | 235 | 235 | 235 | | 82 | | | | 395 | 235 | |
| | (D50: 0.5 μm) | | | | | | | | | | | |
| | R7200 | | | | | | 67 | 235 | | | | |
| | (D50: 12 nm) | | | | | | | | | | | |
| | NP-30 | | | | | | | | 235 | | | |
| | (D50: 3 μm) | | | | | | | | | | | |
| | YA050C-SM1 | | | | | | | | | | | |
| | (D50: 50 nm) | | | | | | | | | | | |
| | YC100C-SM2 | | | | | | | | | | | |
| | D50: 100 nm) | | | | | | | | | | | |
| Photopolymerization | BAPO | 0.7 | 0.7 | 0.7 | 0.7 | 0.7 | 0.7 | 1.0 | 0.7 | 0.7 | 0.7 | 0.7 |
| initiator | | | | | | | | | | | | |
| Other components | D-800 (talc) | | | | | | | | | | | 235 |
| | BYK 111 | | | | | | | | | | | 26.0 |

| | | | | | | | | | | | |
|---|---|---|---|---|---|---|---|---|---|---|---|
| [a] Polycyclic aliphatic acrylic resin | 90 | 100 | 0 | 70 | 70 | 50 | 60 | 70 | 70 | 0 | 70 |
| content in all acrylic resins [wt %] | | | | | | | | | | | |
| [b] Isocyanuric acid acrylic resin content | 10 | 0 | 100 | 30 | 30 | 50 | 40 | 30 | 30 | 30 | 30 |
| in all acrylic resins [wt %] | | | | | | | | | | | |
| [c] 50% average particle size of silica | 0.5 | 0.5 | 0.5 | — | 0.5 | 0.012 | 0.012 | 3 | 0.5 | 0.5 | 0.8 |
| particles (talc) [μm] | | | | | | | | | | | |
| [d] Silica particle content based on total | 70 | 70 | 70 | 0 | 45 | 40 | 70 | 70 | 80 | 70 | 0 |
| resin composition [wt %] | | | | | | | | | | | |
| Bending strength [MPa] | 133 | 123 | 130 | 155 | 157 | 95 | *— | 87 | *— | 159 | 80 |
| Thermal expansion coefficient [ppm/K] | 27 | 28 | 20 | 63 | 43 | 42 | *— | 22 | *— | 35 | 22 |
| Durability of molded body | C | C | C | C | C | B | B | C | C | C | D |

*No stereolithographic object could be fabricated

As shown in Table 1, Examples 1 to 7, which satisfied the above conditions [a] to [d], all had a bending strength of 174 MPa or more, which was a sufficiently high value. Furthermore, Examples 1 to 7 also all had a thermal expansion coefficient to 35 ppm/K or less.

On the other hand, as shown in Table 2, when the conditions [a] and/or [b] were not satisfied, that is, when the content of the polycyclic aliphatic acrylic resin and the content of the isocyanuric acid acrylic resin were not in an appropriate range (Comparative example 1) or when either the polycyclic aliphatic acrylic resin or the isocyanuric acid acrylic resin was not contained (Comparative examples 2, 3, and 10), the thermal expansion coefficient was satisfactory, but the bending strength was low in all cases. It is considered that one of the reasons is that the network was not formed by the polycyclic aliphatic acrylic resin and the isocyanuric acid acrylic resin.

In Comparative examples 4 and 5 in which the amount of the silica particles was too small (did not satisfy the condition [d]), the bending strength was low in both cases, and also the thermal expansion coefficient was high. Furthermore, in Comparative example 9 in which the amount of the silica particles was too large (did not satisfy the condition [d]), the viscosity increased, and the stereolithographic object could not be produced.

In addition, in Comparative example 6 in which the 50% average particle size of the silica particles was too small and the amount of the silica particles was small (did not satisfy the conditions [c] and [d]), the silica particles could not contribute to the improvement of the bending strength or the reduction of the thermal expansion coefficient, and thus the bending strength was low and also the thermal expansion coefficient was high. Furthermore, in Comparative example 7 in which the 50% average particle size of the silica particles was too small (did not satisfy the condition [d]), when a large amount of silica particles were added so as to satisfy the condition [c], the viscosity increased, and a stereolithographic object could not be produced.

On the other hand, in Comparative example 8 in which the 50% average particle size of the silica particles was too large (did not satisfy the condition [d]), the bending strength was extremely low.

Furthermore, when talc was used instead of the silica particles, even when the 50% average particle size or the amount of the talc satisfied the above-described conditions (the conditions [c] and [d]), the bending strength was not sufficiently improved. It is considered that, when talc was used, the polycyclic aliphatic acrylic resin and the isocyanuric acid acrylic resin network could not be efficiently reinforced.

### 2. FIRST REFERENCE EXAMPLE

### 2-1. Preparation of Materials

The following materials were used in the reference examples.

### (Polycyclic Aliphatic Acrylic Resin)

IRR-214K (tricyclodecane dimethanol diacrylate, manufactured by Daicel-Allnex Ltd.)

### (Isocyanuric Acid Acrylic Resin)

A-9300S (tris[2-(acryloyloxy)ethyl] isocyanurate, manufactured by Shin-Nakamura Chemical Co., Ltd., product name: NK ESTER A-9300S)

### (Photopolymerization Initiator)

Omnirad 819 (phenylbis(2,4,6-trimethylbenzoyl) phosphine oxide, manufactured by IGM Resins)

### (Silica Particles)

SC2500-SMJ (surface-treated with methacryl silane, manufactured by Admatechs Co., Ltd., product name: Admafine SC2500-SMJ, 50% average particle size (median value of volume particle size distribution measured by laser diffraction method): 0.5 μm)
R7200 (surface-treated with methacryl silane, manufactured by Nippon Aerosil Co., Ltd., product name: AEROSIL R7200, 50% average particle size (median value of volume particle size distribution measured by laser diffraction method): 12 nm)
NP-30 (SANSFARE NP-30, manufactured by AGC Si-Tech Co., Ltd., 50% average particle size (median value of volume particle size distribution measured by laser diffraction method): 3 μm)

### 1-2. Preparation of Photocurable Resin Composition

### Reference Example 1

### Preparation of Photocurable Resin Composition for Base Material

In this preparation, 70 parts by mass of the polycyclic aliphatic acrylic resin (tris[2-(acryloyloxy)ethyl] isocyanurate), 30 parts by mass of the isocyanuric acid acrylic resin (tris[2-(acryloyloxy)ethyl] isocyanurate), and 0.7 parts by mass of the photopolymerization initiator (phenylbis(2,4,6-trimethylbenzoyl) phosphine oxide) were weighed and placed in a beaker. These compounds were stirred while being heated at 60° C. for 2 hours, and it was confirmed that a homogeneous solution was obtained. Thereafter, 235 parts by mass of the silica particles (SC2500-SMJ) were added to the solution, which was kneaded and defoamed with a planetary centrifugal mixer SK-300TVS (manufactured by Shashin Kagaku Co., Ltd.). As a result, a photocurable resin composition for a base material was prepared.

### Preparation of Photocurable Resin Composition for Coating Layer

In this preparation, 2.0 parts by mass of the photoradical polymerization initiator (phenylbis(2,4,6-trimethylbenzoyl) phosphine oxide) was added to 100 parts by mass of the polycyclic aliphatic acrylic resin (tricyclodecane dimethanol diacrylate). These compounds were placed in a beaker, stirred while being heated at 60° C. for 1 hour, and a photocurable resin composition for a coating layer was prepared.

### Comparative Reference Examples 1 to 3

As shown in Table 3, a photocurable resin composition for a base material and a photocurable resin composition for a coating layer were prepared in the same manner as in Reference example 1, except that the amount and type of silica particles in the photocurable resin composition for a base material were changed.

### 2-3. Evaluation Method

For each of the photocurable resin compositions for a base material and for a coating layer prepared in Reference example 1 and Comparative examples 1 to 3, a stereolithographic object was produced by the following method, and each prepared stereolithographic object was evaluated. The results are shown in Table 3.

### (Method for Producing Stereolithographic Object)

### Production of Base Material

A 1 mm-thick spacer having a donut shape (a disk having a size of φ80 mm and having a through-hole of φ50 mm at the center) was placed on a black anodized aluminum plate (0.5 mm thick) that had been subjected to a release treatment. The above-described photocurable resin composition for a base material was poured into a recessed portion formed by a wall surrounding the through-hole of the spacer and the black plate. Thereafter, a glass plate that had been subjected to a release treatment was disposed on the spacer. Then, half of the region (a semicircular region) of the through-hole of the glass plate was masked with a black tape. In this state, the photocurable resin composition for a base material was irradiated with light from the glass plate side for 5 seconds using a UV lamp (365 nm). Thereafter, the uncured portion was wiped off with a nonwoven fabric and air-blowing was performed to obtain a base material.

### Formation of Coating Layer

The composition for a coating layer was applied onto the surface of the base material with a brush. Then, the composition for a coating layer was irradiated with light from one surface side for 5 seconds using a UV lamp (365 nm) to form a coating layer.

### (Evaluation of Durability)

A 0.5 mm-thick anodized aluminum plate was pressed vertically against an end surface (a portion at the arc) of the produced semicircular molded article and rubbed. At this time, a case where no shaving powder was generated from the stereolithographic object was evaluated as A (durability was satisfactory), and a case where the shaving powder was generated was evaluated as B (durability was poor).

### 2-3. Results

TABLE 3

| | | | | Comp. | Comp. | Comp. |
|---|---|---|---|---|---|---|
| | | | Reference | reference | reference | reference |
| | | | example 1 | example 1 | example 2 | example 3 |
| Photocurable | Polyfunctional | IRR-214K | 70 | 70 | 70 | 70 |
| resin | acrylic resin | A-9300S | 30 | 30 | 30 | 30 |
| composition for | Photopolymerization | Omnirad 819 | 1 | 1 | 1 | 1 |
| base material | initiator | | | | | |
| | Silica particle | SC2500-SMJ | 235 | — | — | — |
| | | R7200 | — | 44 | 235 | — |
| | | NP-30 | — | — | — | 235 |
| | Silica concentration | | 70 | 30 | 70 | 70 |
| | in composition (%) | | | | | |
| Photocurable | Acrylic resin | IRR-214K | 100 | 100 | 100 | 100 |
| resin | Initiator | Omnirad 819 | 1 | 1 | 1 | 1 |
| composition for | | | | | | |
| coating layer | | | | | | |

| | | | | | |
|---|---|---|---|---|---|
| Evaluation | Durability | A | B | *— | B |

*No stereolithographic object could be fabricated

In Reference example 1, the detachment of the powder silica particles was not confirmed, and the durability of the coating layer was sufficient. On the other hand, in Comparative reference example 1, the generation of shaving powder was confirmed. It is considered that the average particle size of the silica particles was too small, so that a sufficient anchor effect was not generated, resulting in insufficient durability of the coating layer. In addition, in Comparative reference example 2, the base material itself could not be fabricated by stereolithography. Furthermore, in Comparative reference example 3, the generation of shaving powder was confirmed. In this case, it is considered that the average particle size of the silica particles was too large, so that a sufficient anchor effect was not generated, resulting in insufficient durability of the coating layer.

### 3. SECOND REFERENCE EXAMPLE

### 3-1. Preparation of Surface-Treated (or Untreated) Filler

### Reference Example A

An Al₂O₃ film (metal-containing film) having a thickness of 45 nm was formed on the surface of MnCuSnN, namely a microfiller (coefficient of thermal expansion at 25° C. to 60° C.:-22 ppm/K) by an atomic layer deposition (ALD) method. Then, a silane coupling treatment was performed using A-1110, namely a silane coupling agent (Silquest A-1110, manufactured by Momentive Performance Materials Inc.) to obtain surface-treated inorganic particles.

### Comparative Reference Examples a to d

As shown in Table 4, surface-treated (or untreated) inorganic particles were obtained in the same manner as described above, except that a metal-containing film was not formed and/or the treatment with the silane coupling agent was not performed.

### Reference Examples B and C, and Comparative Reference Examples e to h

As shown in Table 5, surface-treated (or untreated) inorganic particles were obtained in the same manner as in Reference example A and Comparative reference examples a to d, except that ZMP (ZnO: 30 to 40% by mass, MgO: 1 to 9% by mass, NH₄H₂PO₄: 55 to 65% by mass, average particle size D50: 4 to 5 μm, manufactured by Mitsui Mining & Smelting Co., Ltd.) was used instead of MnCuSnN.

### 3-2. Production of Molded Article

HTM140V2 (resin composition for three-dimensional modeling, manufactured by EnvisionTEC) and AEROSIL R7200 (manufactured by Nippon Aerosil Co., Ltd.) were mixed at each mass ratio shown in Tables 4 and 5. Furthermore, the above-described surface-treated (or untreated) inorganic particles were mixed to obtain a mixture. A 1 mm-thick spacer having a donut shape (a disk having a size of φ80 mm and having a through-hole of φ50 mm at the center) was placed on a glass plate that had been subjected to a release treatment. The above-described mixture was poured into a recessed portion formed by a wall surrounding the through-hole of the spacer and the glass plate. Thereafter, another glass plate that had been subjected to a release treatment was placed on the spacer to sandwich the mixture. Then, the mixture was irradiated with light having a wavelength of 365 nm from both surfaces for 26 seconds each by using an ultra-high pressure mercury lamp (UV-800, manufactured by OAK Corporation). Thereafter, the mixture was heated in an oven at 180° C. for 1 hour to obtain a molded article. In Reference comparative example X in Table 4, a molded article was obtained without adding the surface-treated (or untreated) inorganic particles. In addition, each molded article was cut into a size of 3 mm×15 mm with a cutting machine, and the cut piece was used as a test piece.

### 3-3. Evaluation

The mixture before curing and the molded article after the curing were evaluated by the following method. The results are shown in Tables 4 and 5. In addition, the FIGURE illustrates photographs of the obtained molded articles when each molded article was observed with a scanning electron microscope.

### (Viscosity)

The viscosity of the mixture before curing was measured at room temperature and a shear rate of 1 (1/s) using a rheometer (Discovery HR-2, manufactured by TA Instruments) 90 seconds after the start of rotation. The viscosity was measured three times, and the average value thereof was used.

### (Coefficient of Thermal Expansion)

For each molded article, the coefficient of thermal expansion in a range of ~40° C. to 25° C., the coefficient of thermal expansion in a range of 25° C. to 150° C., and the coefficient of thermal expansion in a range of ~40° C. to 150° C. were evaluated using a thermal analysis device Thermo Plus EV02 TMA8311/LN2 (manufactured by Rigaku Corporation) with reference to JIS K-7197.

### (Bending Test (Bending Stress, Breaking Elongation, and Elastic Modulus))

Each molded article was subjected to a bending test under the condition of 10 mm/min at 23° C. with an automatic load tester (MAX-1 kN-H, manufactured by Nippon Seisakusho Ltd.) to specify a bending stress, a breaking elongation, and an elastic modulus.

### (DMA Measurement (Elastic Modulus at 150° C. And 170° C.))

Each molded article was subjected to dynamic viscoelasticity (DMA) measurement to specify the elastic modulus at 150° C. and 170° C.

### (Evaluation of Adhesiveness)

The adhesiveness between the surface-treated (or untreated) filler and the resin was confirmed with a scanning electron microscope (SEM), and was evaluated as follows.
A (satisfactory): the surface of the filler was covered with the resin, and almost no filler was exposed
B (mottled): a part of the surface of the filler was covered with the resin
C (slightly): the surface of the filler was not covered, but the resin was attached to the surface
D (slightly): the resin was hardly attached to the surface of the filler, and the side surface of the filler was embedded in the resin
E (almost none): the resin was hardly attached to the surface of the filler, and the side surface of the filler was also exposed

### 3-4. Results

TABLE 4

| | | Comp. | | | | | |
|---|---|---|---|---|---|---|---|
| | | reference | Comp. | Comp. | Comp. | Comp. | Reference |
| | | example | reference | reference | reference | reference | example |
| | | X | example a | example b | example c | example d | A |
| Surface-treated | Filler | — | MnCuSnN | | | | |
| (or untreated) | Metal- | — | — | — | Al₂O₃ | SiO₂ | Al₂O₃ |
| inorganic | containing | | | | | | |
| particle | film | | | | | | |
| | Silane | — | — | A-1110 | — | — | A-1110 |
| | coupling | | | | | | |
| | agent | | | | | | |
| Inorganic particle (% by mass) | | — | 50.0 | 50.1 | 50.1 | 50.0 | 49.8 |
| HTM140V2 (% by mass) | | 72.0 | 36.0 | 35.9 | 35.9 | 36.0 | 36.1 |
| R7200 (% by mass) | | 28.0 | 14.0 | 14.0 | 14.0 | 14.0 | 14.0 |
| 1 rpm viscosity (mPa · s) | | 11590 | 296100 | 206704 | 473500 | *¹— | 258520 |
| Linear | −40 to +25 | 39.89 | 29.86 | 27.44 | 27.15 | 25.39 | 27.19 |
| expansion | (ppm/° C.) | | | | | | |
| coefficient | +25 to +150 | 41.57 | 41.17 | 44.28 | 41.09 | 45.1 | 42.83 |
| | (ppm/° C.) | | | | | | |
| | −40 to +150 | 43.45 | 37.37 | 37.57 | 36.27 | 38.29 | 37.43 |
| | (ppm/° C.) | | | | | | |

| | | | | | | |
|---|---|---|---|---|---|---|
| 23° C. bending stress (MPa) | 124 | 90.5 | 97.2 | 85.5 | 93.8 | 91.4 |
| 23° C. breaking elongation (%) | 3.69 | 1.64 | 1.65 | 1.47 | 1.71 | 1.55 |
| 23° C. elastic modulus (MPa) | 3877 | 5513 | 6317 | 5658 | 6112 | 6078 |
| (DMA)150° C. elastic modulus | — | 4972 | 4576 | 5110 | 4161 | 4610 |
| (MPa) | | | | | | |
| (DMA)170° C. elastic modulus | — | 4548 | 3984 | 4648 | 3753 | 4217 |
| (MPa) | | | | | | |
| Adhesiveness | — | E | C | E | C | A |

*¹Cured during mixing

TABLE 5

| | | Comp. | Comp. | Comp. | Comp. | Reference | Reference |
|---|---|---|---|---|---|---|---|
| | | reference | reference | reference | reference | example | example |
| | | example e | example f | example g | example h | B | C |
| Surface-treated | Filler | ZMP | | | | | |
| (or untreated) | Metal- | — | — | Al₂O₃ | SiO₂ | Al₂O₃ | SiO₂ |
| inorganic particle | containing | | | | | | |
| | film | | | | | | |
| | Silane | — | A-1110 | — | — | A-1110 | A-1110 |
| | coupling | | | | | | |
| | agent | | | | | | |
| Inorganic particle (% by mass) | | 35.5 | 35.5 | 35.3 | 35.3 | 35.4 | 35.5 |
| HTM140V2 (% by mass) | | 46.3 | 46.4 | 46.6 | 46.6 | 46.5 | 46.5 |
| R7200 (% by mass) | | 18.1 | 18.0 | 18.1 | 18.1 | 18.1 | 18.1 |
| 1 rpm viscosity (mPa · s) | | 184400 | 228001 | *²386000 | *²347325 | 251081 | 190456 |
| Linear expansion | −40 to +25 | 28.38 | 25.94 | 23.19 | 24.34 | 22.97 | 25.01 |
| coefficient | (ppm/° C.) | | | | | | |
| | +25 to +150 | 29.30 | 29.15 | 29.70 | 29.16 | 30.26 | 27.91 |
| | (ppm/° C.) | | | | | | |
| | −40 to +150 | 29.24 | 28.04 | 27.45 | 27.49 | 27.74 | 26.92 |
| | (ppm/° C.) | | | | | | |

| | | | | | | |
|---|---|---|---|---|---|---|
| 23° C. bending stress (MPa) | 110.9 | 109.2 | 95 | 88.2 | 111.1 | 118.4 |
| 23° C. breaking elongation (%) | 2.20 | 1.95 | 1.68 | 1.46 | 1.99 | 2.06 |
| 23° C. elastic modulus (MPa) | 5317 | 6119 | 6179 | 6452 | 5988 | 6178 |
| 150° C. elastic modulus (MPa) | 5533 | 4950 | 5565 | 5325 | 5523 | 5471 |
| 170° C. elastic modulus (MPa) | 5142 | 4654 | 5229 | 4988 | 5173 | 5154 |
| Adhesiveness | D | B | C | C | B | A |

*²Particles remain

As shown in Tables 4 and 5 and the FIGURE, when the metal-containing film was formed on the surface of the filler and the silane coupling agent was further disposed (Reference examples A, B, and C), the adhesiveness between the inorganic particles and the resin was excellent as compared with Reference comparative example X in which the inorganic particles were not added. In addition, by adding the inorganic particles, the coefficient of thermal expansion of the molded article was reduced, and also the elastic modulus was increased.

On the other hand, when untreated inorganic particles were added, the adhesiveness between the inorganic particles and the resin was extremely low (Comparative reference examples a and e). Furthermore, when the filler was treated only with the silane coupling agent, the adhesiveness was improved in some cases depending on the combination with the filler (for example, Comparative reference example f), but the adhesiveness was decreased when the type of filler was changed (for example, Comparative reference example b). Furthermore, when only the metal-containing film was formed and the silane coupling agent was not used for treatment, it was difficult to obtain sufficient adhesiveness in all cases (Comparative reference examples c, d, g, and h).

### INDUSTRIAL APPLICABILITY

The photocurable resin composition according to the present invention is capable of providing a molded article having both high strength and low thermal expansion coefficient. The molded article can be used for various use, for example, electrical components.

1. A photocurable resin composition, comprising:
a polyfunctional acrylic resin; a silica particle; and a photopolymerization initiator, wherein
the polyfunctional acrylic resin contains 20% by mass or more and 80% by mass or less of a polycyclic aliphatic acrylic resin and 20% by mass or more and 80% by mass or less of an isocyanuric acid acrylic resin,
the silica particle has a 50% average particle size of 30 nm or more and less than 1.0 μm, and
an amount of the silica particle is 60% by mass or more and less than 80% by mass based on a total mass of the photocurable resin composition.

2. The photocurable resin composition according to claim 1, wherein
the silica particle is surface treated with a compound having a (meth)acryloyl group.

3. The photocurable resin composition according to claim 1, wherein
the polycyclic aliphatic acrylic resin is tricyclodecane dimethanol diacrylate.

4. The photocurable resin composition according to claim 1, wherein
the isocyanuric acid acrylic resin is a compound represented by a general formula below: 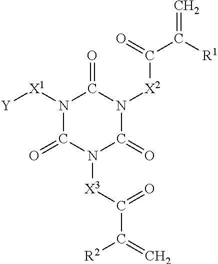
(in the general formula, X¹, X², and X³ each independently represent a linking group having 1 or more and 20 or less carbon atoms and optionally containing oxygen, R¹ and R² each independently represent a hydrogen atom or a methyl group, and Y represents a (meth)acryloyl group or a hydroxy group).

5. A molded article, comprising:
a cured product of the photocurable resin composition according to claim 1.

6. The molded article according to claim 5, comprising:
the cured product of the photocurable resin composition; and
a coating layer disposed on the cured product and containing a polycyclic aliphatic acrylic resin.

7. An electrical component, comprising:
the molded article according to claim 5.
